(19) United States
(12) Patent Application Publication
(10) Pub. No.: US 2026/0296944 A1
(43) Pub. Date: Oct. 1, 2026

(54) FLUID PURIFICATION DEVICE USING NANO FILTRATION

(71) Applicant: Unger Marketing International, LLC, Bridgeport, CT (US)

(72) Inventors: Stephen P. Huda, Shelton, CT (US); James M. Buckley, New Hartford, CT (US)

(21) Appl. No.: 19/576,783

(22) Filed: Mar. 24, 2026

Related U.S. Application Data
(60) Provisional application No. 63/779,359, filed on Mar. 28, 2025.

(51) Int. Cl. C02F 9/20

(52) U.S. Cl. CPC C02F 9/20; C02F 2201/004; C02F 2201/005; C02F 2209/40

(57) ABSTRACT

A fluid purification device is provided. The fluid purification device includes a first filter, a second filter, a bypass valve in fluid communication between the first filter and the second filter, a fluid blender in fluid communication with the bypass valve and the second filter, and a third filter. The first filter includes a prefilter in fluid communication with a fluid inlet for the fluid purification device to receive fluid from the fluid inlet and output prefiltered fluid. The second filter includes a nanofilter in fluid communication with the first filter to receive the prefiltered fluid and output nanofiltered fluid. The bypass valve variably controls flow of the prefiltered fluid therethrough. The fluid blender receives the prefiltered fluid from the first filter via the bypass valve and the nanofiltered fluid from the second filter and outputs a blended fluid. The third filter includes a filtration medium in fluid communication with the fluid blender to receive the blended fluid and output pure fluid.

### CROSS-REFERENCE

This application claims the benefit of U.S. Provisional Application Ser. No. 63/779,359, filed Mar. 28, 2025, the entire disclosure of which is incorporated herein by reference.

### BACKGROUND

The subject matter disclosed herein relates to a fluid purification device, and in particular to a fluid purification device having one or more mechanical filters.

It is desirable to use purified water (referred to herein as “pure water”) in various cleaning applications. One common cleaning application for pure water is the cleaning of windows, cars, buildings, solar panels, and other surfaces. For example, the use of pure water in the form of deionized (DI) water, also known as demineralized (DM) water, has been found to be effective when cleaning smooth or reflective surfaces such as metal, glass, ceramics, tile, plastics, and others. The pure water can reduce the formation of water marks and spots, which can be formed by impurities in untreated water that remain on the surface when the water dries.

Many pure water systems use one or more types of purification media alone or in combination with other devices/processes such as, but not limited to, particle filtration, distilling (i.e., distilled water), reverse osmosis, desalination, carbon filtration, microfiltration, ultrafiltration, ultraviolet oxidation, electrodialysis, nanofiltration, others, and any combinations thereof.

Some pure water systems improve and extend the lifecycle of the primary filter by using one or more mechanical filters to remove impurities by reducing the total dissolved solids (TDS) in the water. This in turn reduces how quickly the primary filter is depleted. Still further pure water systems condition the water by adding to or removing one or more components from the input water.

Accordingly, while existing water conditioning systems are suitable for their intended purposes the need for improvement remains, particularly in providing a fluid purification device having the features described herein.

### BRIEF DESCRIPTION

According to some embodiments, fluid purification devices are provided. The fluid purification devices include a first filter, a second filter, a bypass valve in fluid communication between the first filter and the second filter, a fluid blender in fluid communication with the bypass valve and the second filter, and a third filter. The first filter includes a prefilter in fluid communication with a fluid inlet for the fluid purification device. The first filter is configured to receive fluid from the fluid inlet and output prefiltered fluid. The second filter includes a nanofilter in fluid communication with the first filter. The second filter is configured to receive the prefiltered fluid and output nanofiltered fluid. The bypass valve is configured to variably control flow of the prefiltered fluid therethrough. The fluid blender is configured to receive the prefiltered fluid from the first filter via the bypass valve and the nanofiltered fluid from the second filter and output a blended fluid. The third filter configured to receive the blended fluid and output pure fluid.

In addition to one or more of the features described above, or as an alternative, further embodiments of the fluid purification devices may include a manifold valve assembly in fluid communication with the prefilter. The manifold valve assembly is configured to direct the prefiltered fluid between one or more outputs of the manifold valve assembly.

In addition to one or more of the features described above, or as an alternative, further embodiments of the fluid purification devices may include the one or more outputs of the manifold valve assembly including a first output in fluid communication with the bypass valve to direct the prefiltered fluid into the bypass valve.

In addition to one or more of the features described above, or as an alternative, further embodiments of the fluid purification devices may include the one or more outputs of the manifold valve assembly including a second output in fluid communication with the third filter to direct the prefiltered fluid into the third filter.

In addition to one or more of the features described above, or as an alternative, further embodiments of the fluid purification devices may include a bypass hose extending between the bypass valve and the fluid blender, the bypass hose configured to transport the prefiltered fluid from the manifold valve assembly to the fluid blender.

In addition to one or more of the features described above, or as an alternative, further embodiments of the fluid purification devices may include a top assembly including the fluid inlet, wherein the first filter is coupled to the top assembly to produce the prefiltered fluid from the fluid from the inlet.

In addition to one or more of the features described above, or as an alternative, further embodiments of the fluid purification devices may include the top assembly including a control knob configured to actuate the bypass valve to regulate a flow of the prefiltered fluid from the first filter to the fluid blender.

In addition to one or more of the features described above, or as an alternative, further embodiments of the fluid purification devices may include the control knob is rotatable between a plurality of discrete positions to actuate the bypass valve variably adjust the flow of the prefiltered fluid from the first filter to the fluid blender.

In addition to one or more of the features described above, or as an alternative, further embodiments of the fluid purification devices may include the blended fluid including a greater volume of prefiltered fluid when the flow of the prefiltered fluid to the fluid blender is increased.

In addition to one or more of the features described above, or as an alternative, further embodiments of the fluid purification devices may include a flow rate of the pure fluid changing in response to an adjustment of the flow of the prefiltered fluid from the first filter to the fluid blender.

In addition to one or more of the features described above, or as an alternative, further embodiments of the fluid purification devices may include the top assembly including a plurality of flow indicators, each flow indicator corresponding to one of the plurality of discrete positions of the control knob.

In addition to one or more of the features described above, or as an alternative, further embodiments of the fluid purification devices may include a nanofiltration assembly including the second filter, wherein the top assembly is secured to the nanofiltration assembly.

In addition to one or more of the features described above, or as an alternative, further embodiments of the fluid purification devices may include a primary filtration assembly including the third filter, wherein the primary filtration assembly is detachably coupled to a bottom assembly.

In addition to one or more of the features described above, or as an alternative, further embodiments of the fluid purification devices may include the bottom assembly being secured to the nanofiltration assembly.

In addition to one or more of the features described above, or as an alternative, further embodiments of the fluid purification devices may include the fluid blender including a T-junction fitting.

According to some embodiments, fluid purification devices are provided. The fluid purification devices include a top assembly, a nanofiltration assembly, a primary filtration assembly, and a fluid blender. The top assembly includes a prefilter in fluid communication with a fluid inlet for the fluid purification device. The prefilter is configured to receive fluid from the fluid inlet and output prefiltered fluid. The nanofiltration assembly includes a nanofilter in fluid communication with the prefilter. The nanofilter is configured to receive the prefiltered fluid and output nanofiltered fluid. The primary filtration assembly includes a filtration medium in fluid communication with the nanofilter. The primary filtration assembly is configured to receive the nanofiltered fluid and output pure fluid. The fluid blender is in fluid communication with the top assembly, the nanofiltration assembly, and the primary filtration assembly. The fluid blender configured to receive at least one of the prefiltered fluid and the nanofiltered fluid and output a blended fluid to the primary filtration assembly. The bottom assembly supports the primary filtration assembly. The bottom assembly and the top assembly are secured to and supported by the nanofiltration assembly.

In addition to one or more of the features described above, or as an alternative, further embodiments of the fluid purification devices may include a bypass valve in fluid communication between the prefilter and the nanofilter. The bypass valve configured to variably control flow of the prefiltered fluid therethrough to the fluid blender.

In addition to one or more of the features described above, or as an alternative, further embodiments of the fluid purification devices may include the top assembly including a control knob configured to actuate the bypass valve to variably control flow of the prefiltered fluid from the top assembly to the fluid blender.

In addition to one or more of the features described above, or as an alternative, further embodiments of the fluid purification devices may include the control knob being rotatable between a plurality of discrete positions to actuate the bypass valve variably adjust the flow of the prefiltered fluid from the top assembly to the fluid blender.

In addition to one or more of the features described above, or as an alternative, further embodiments of the fluid purification devices may include the blended fluid including a greater volume of prefiltered fluid when the flow of the prefiltered fluid to the fluid blender is increased.

### BRIEF DESCRIPTION OF THE DRAWINGS

The following descriptions should not be considered limiting in any way. With reference to the accompanying drawings, like elements are numbered alike:

FIG. 1 is a perspective view of a fluid purification device according to an embodiment;

FIG. 2 is a side view of the fluid purification device of according to an embodiment;

FIG. 3 is a perspective view of a top assembly of the fluid purification device according to an embodiment;

FIG. 4 is a bottom view of the top assembly of the fluid purification device according to an embodiment;

FIG. 5 is a cross sectional view of the top assembly of the fluid purification device according to an embodiment;

FIG. 6 is a perspective view of a nanofiltration assembly of the fluid purification device according to an embodiment;

FIG. 7 is a cross sectional view of the nanofiltration assembly of the fluid purification device according to an embodiment;

FIG. 8 is a truncated perspective view of the nanofiltration assembly and a bottom assembly of the fluid purification device according to an embodiment;

FIG. 9 is a truncated cross sectional view of the top assembly and the nanofiltration assembly of the fluid purification device according to an embodiment;

FIG. 10 is a perspective view of the bottom assembly of the fluid purification device according to an embodiment;

FIG. 11 is a bottom view of the bottom assembly of the fluid purification device according to an embodiment;

FIG. 12 is a bottom view of the bottom assembly and the nanofiltration assembly of the fluid purification device according to an embodiment;

FIG. 13 is a bottom view of the bottom assembly and a kickplate of the bottom assembly according to an embodiment;

FIG. 14 is a perspective view of the primary filtration assembly of the fluid purification device according to an embodiment;

FIG. 15 is a bottom view of the primary filtration assembly of the fluid purification device according to an embodiment;

FIG. 16 is a cross sectional view of the primary filtration assembly of the fluid purification device according to an embodiment;

FIG. 17 is a cross sectional view of the primary filtration assembly of the fluid purification device according to an embodiment; and

FIGS. 18A and 18B are side views of the fluid purification device being loaded and unloaded from a vehicle.

### DETAILED DESCRIPTION

A detailed description of one or more embodiments of the disclosed apparatus and method are presented herein by way of exemplification and not limitation with reference to the Figures.

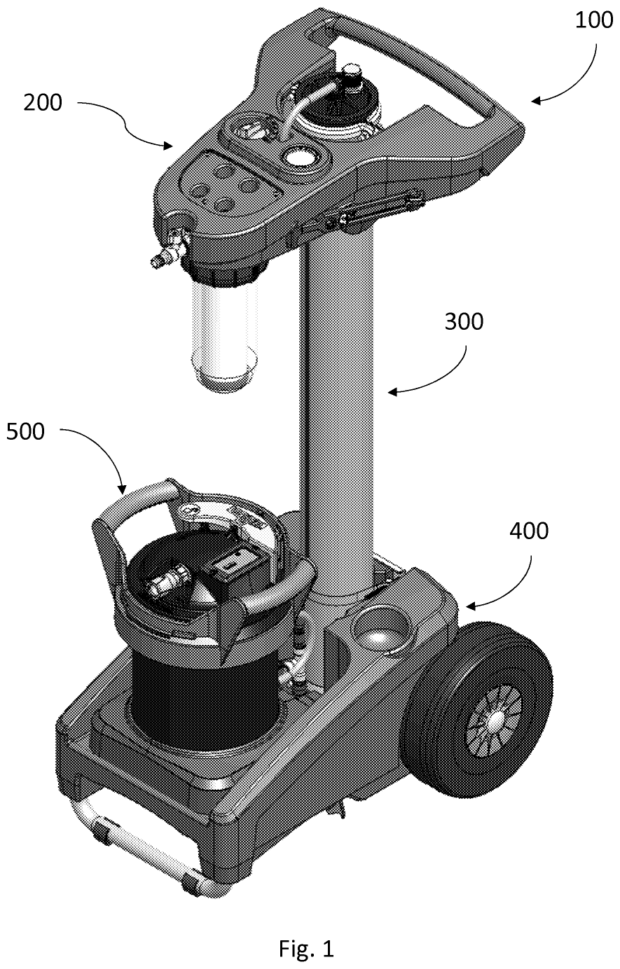

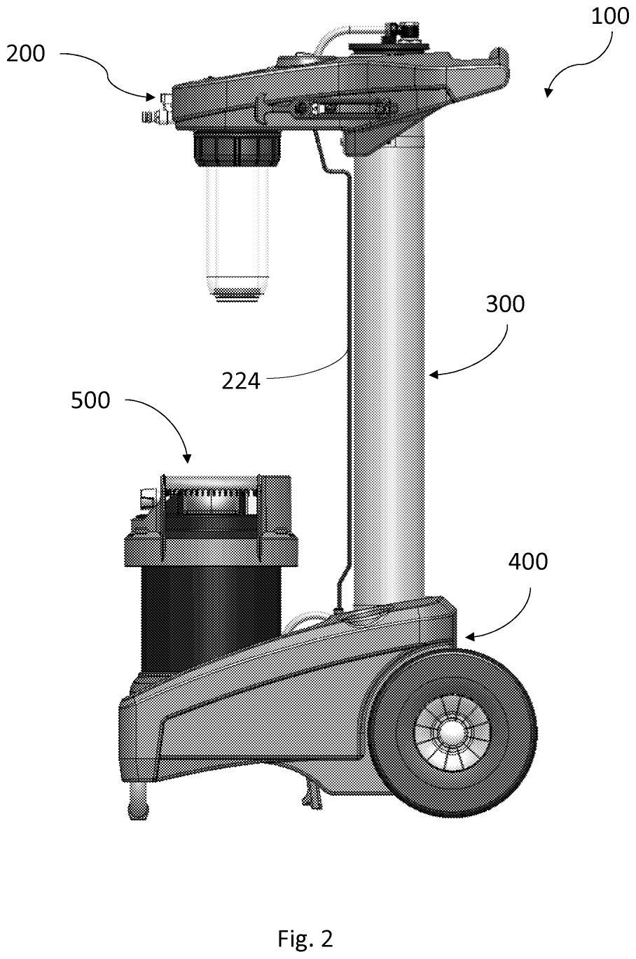

Referring now to FIGS. 1 and 2, shown is a perspective and side view of a fluid purification device 100 according to some embodiments of the present disclosure. The fluid purification device 100 may include four major components, the top assembly 200, the nanofiltration assembly 300, the bottom assembly 400, and the primary filtration assembly 500. Each of the subassemblies are discussed in greater detail herein. It should be appreciated that additional subassemblies may be added or removed from the fluid purification device 100 without departing from the scope of the present disclosure. For example, prefilter subassemblies may be added to further condition the water or the primary filtration assembly 500 may be removed and the fluid purification device 100 is used with only the top assembly 200, the nanofiltration assembly 300, the bottom assembly 400.

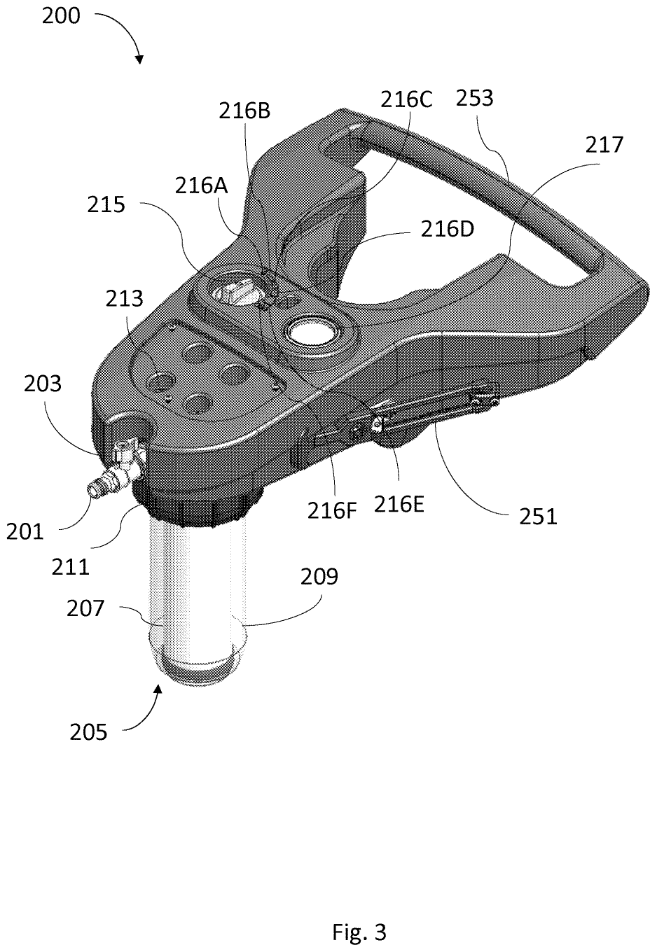

Referring now to FIG. 3, shown is a perspective view of the top assembly 200 of the fluid purification device 100 according to some embodiments of the present disclosure. The top assembly 200 may include a fluid inlet 201 with a valve 203 to control the flow of fluid to the top assembly 200 from a fluid source (not shown). The valve 203 may be a toggle valve which is actuatable between an open and a closed position or a variable valve whereby the flow of fluid is variably increased and decreased as the valve is opened and closed, respectively. A prefilter assembly 205 is disposed to within the top assembly 200 to be in fluid communication with the fluid inlet 201 to allow the prefilter assembly 205 to receive the fluid provided to the top assembly from a fluid source (not shown).

The prefilter assembly 205 may include a prefilter 207 in a prefilter housing 209. In some embodiments, the prefilter 207 may be a carbon block prefilter. The prefilter 207 is configured to receive fluid directed into the top assembly 200 through the fluid inlet 201. The prefilter 207 is configured to remove larger particulates from the fluid directed into the top assembly 200 and output a prefiltered fluid. For example, the prefilter 207 is configured to remove silt, rust, chlorine, or the like such that the prefilter 207 minimizes the presence of large particulates in the prefiltered fluid. These large particulates may be harmful to and reduce a useful life of other components of the fluid purification device 100, such as the nanofiltration assembly 300 and/or the primary filtration assembly 500.

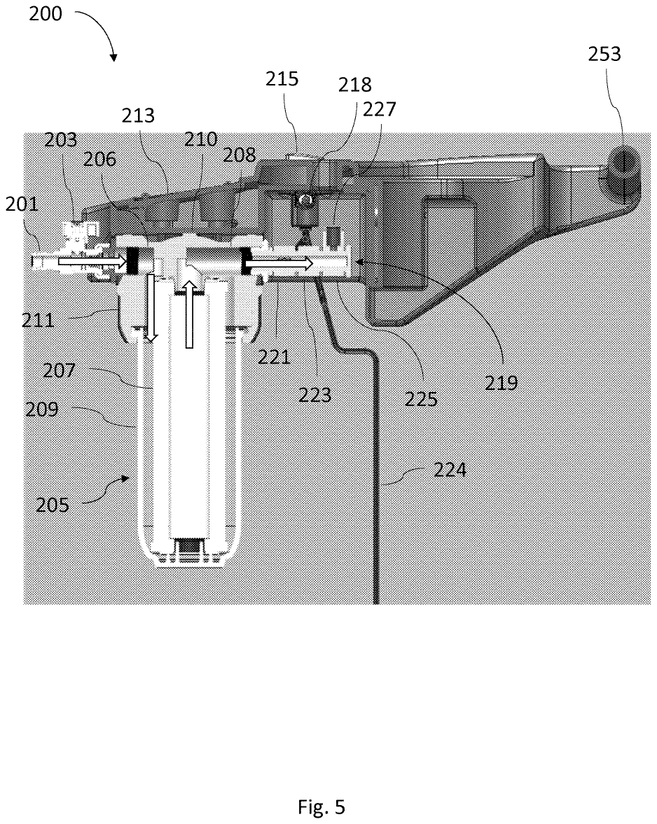

The prefilter housing 209 is releasably secured to a prefilter base 210 (shown in FIG. 5) by a prefilter cap 211 and the prefilter base 210 is in turn secured to the body of the top assembly 200 by one or more fasteners 213, for example screws. In some embodiments, the fasteners 213 sit in recessed holes in the body of the top assembly 200. In this way, the shorter fasteners 213 may be used to secure the prefilter base 210 to the top assembly and the fasteners 213 may be hidden.

In some embodiments, the prefilter cap 211 is a screw cap, whereby the prefilter cap 211 is screwed onto the prefilter base 210 pinning the prefilter housing 209 against the prefilter base 210 and securing the prefilter 207 inside the prefilter housing 209. The prefilter cap 211 may then be unscrewed to release the prefilter housing 209 so that the prefilter 207 can be removed or replaced. For example, over time the activated charcoal in a carbon block prefilter will be depleted and need to be replaced. Alternatively, in some embodiments, the prefilter 207 may be removed and the fluid purification device 100 is operated without the prefilter 207. In this way the fluid purification device 100 can be operated without having to remove the entire prefilter assembly 205. In some embodiments, the prefilter housing 209 is transparent or semi-transparent to provide a visual cue that fluid is flowing through the prefilter assembly 205 as intended or to indicate that the prefilter 207 may need to be replaced.

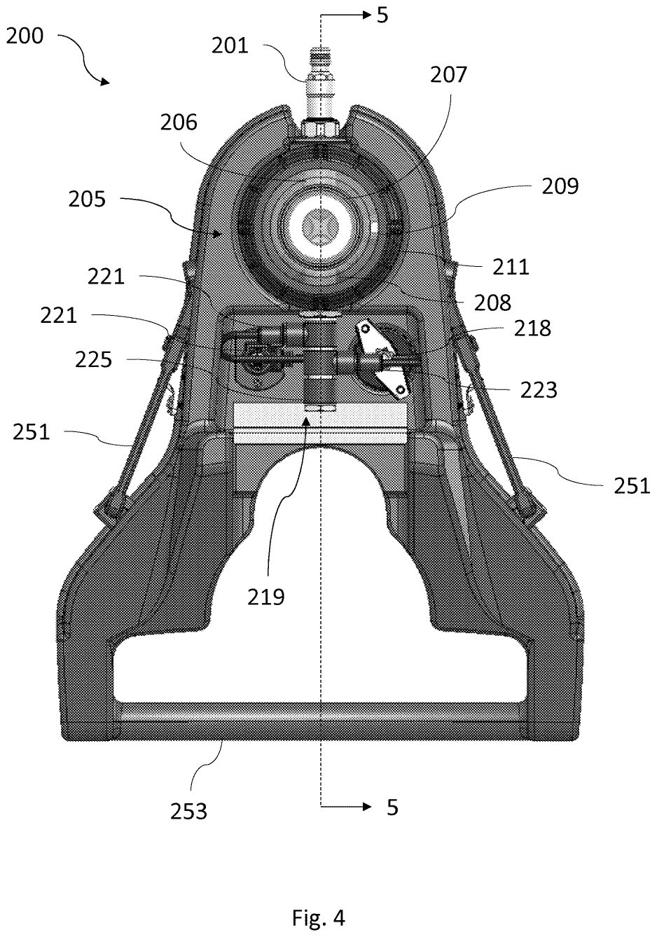

The top assembly 200 may also include a control knob 215 and a pressure gauge 217. The control knob 215 is mechanically coupled to bypass valve 218 to actuate the bypass valve 218 configured to variably control flow of the prefiltered fluid therethrough. The bypass valve 218 regulates a flow and/or a flow rate of the prefiltered fluid from a manifold valve assembly 219 into a bypass hose 224 (FIG. 4) through output 223, as described in more detail below. The bypass hose 224 is configured to transport the prefiltered fluid from the top assembly to the fluid blender 329. The control knob 215 is rotatable to cause corresponding movement of a valve member (not shown) within bypass valve 218 to actuate the bypass valve 218 to direct prefiltered fluid flow into the bypass hose 224 through output 223. The control knob 215 rotatable between a plurality of discrete positions. Each discrete position corresponds to one flow indicator, such as flow indicators 216A-216F (collectively referred to as 216), provided on top assembly 200. The flow indicators 216 provide a visual indication for an adjustment setting of flow into bypass hose 224, as described in more detail below. Although the top assembly 200 illustrated in FIG. 3 has six flow indicators, in some embodiments, the top assembly 200 may have any number of flow indicators as desired.

In some embodiments, the top assembly 200 includes convenience features. For example, the top assembly may include one or more draw latches 251 for securing tools or other equipment, such as cleaning mops, coiled hoses, or other cleaning tools, or a handle 253 to assist in transporting the fluid purification device 100. In some embodiments, the one or more of the draw latches 251 may be replaced or augmented by other storage means, for example a tool pouch or bag, to store various tools, attachments, or replacement parts as desired.

Referring now to FIG. 4, shown is a bottom view of the top assembly 200 according to some embodiments of the present disclosure. As fluid is supplied to the fluid purification device 100, the fluid enters the fluid inlet 201 and flows into a prefilter inlet 204 of the prefilter assembly 205. The fluid then passes through the prefilter 207 and out of the prefilter assembly 205 via a prefilter outlet 208 as the prefiltered fluid. The prefilter outlet 208 is connected to the manifold valve assembly 219. The manifold valve assembly 219 is configured to receive and direct the prefiltered fluid between one or more outputs. For example, in some embodiments, the manifold valve assembly 219 comprises outputs 221, 223, 225 to supply fluid from the prefilter to various subassemblies and sensors.

For example, in some embodiments, output 221 of the manifold valve 219 is connected fluid communication with underside of the pressure gauge 217, output 223 is connected in fluid communication with the bypass valve 218, and output 225 is connected in fluid communication with the nanofiltration assembly 300.

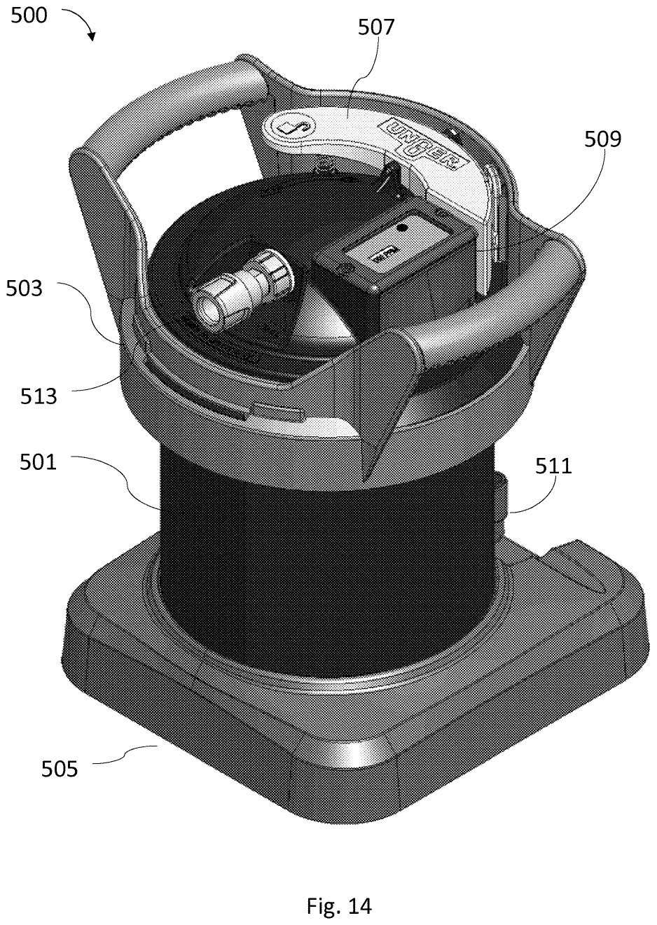

As described above, rotation of the control knob 215 causes adjustment of the flow of the prefiltered fluid through the bypass valve 218 and into the bypass hose 224 through output 223. For example, when the control knob 215 is manually rotated in a first direction, such as in a clockwise direction, flow of the prefiltered fluid into bypass hose 224 is increased. When the control knob 215 is positioned to correspond to flow indicator 216A, the bypass valve 218 is controlled to restrict flow into the bypass hose 224 through second output 223 and an entirety of the flow of prefiltered fluid through the manifold valve assembly 219 is directed into the nanofiltration assembly 300 through the third output 225. When the control knob 215 is positioned to correspond to flow indicator 216B, the bypass valve 218 is controlled to variably increase a portion of the flow of the prefiltered fluid through the manifold valve assembly 219 into the bypass hose 224 through second output 223 compared to when the control knob is positioned to correspond to flow indicator 216A and the flow of the prefiltered fluid from the manifold valve assembly 219 into the nanofiltration assembly 300 through the third output 225 is correspondingly decreased. The bypass valve 218 is controlled to continue to variably increase a portion of the flow of the prefiltered fluid into the bypass hose 224 through second output 223 from the manifold valve assembly 219 as the control knob 215 manually rotated in the first direction to correspond to each of flow indicators 216C, 216D, 216E, and 216F. When the control knob 215 is positioned to correspond to flow indicator 216F, a greatest magnitude of the flow of the prefiltered fluid is directed into the bypass hose 224. For example, when the control knob 215 is positioned to correspond to flow indicator 216F, about 50 percent of the flow of the prefiltered fluid through the manifold valve assembly 219 is directed into bypass hose 224 and about 50 percent of the flow of the prefiltered fluid through the manifold valve assembly 219 is directed into the nanofiltration assembly 300. Increasing the flow of prefiltered fluid into the bypass hose 224 also increases an output volume from the fluid purification device 100 through an outlet 513 (FIG. 14) of the primary filtration assembly 500 when increased output from the fluid purification device 100 is desired.

Additionally, when the control knob 215 is manually actuated in a second direction, such as in a counterclockwise direction, flow of the prefiltered fluid into bypass hose 224 is decreased. The bypass valve 218 is controlled to variably decrease a portion of the flow of the prefiltered fluid into the bypass hose 224 through second output 223 from the manifold valve assembly 219 as the control knob 215 manually rotated in the second direction. Decreasing the flow of the prefiltered fluid into the bypass hose 224 also decreases an output volume from the fluid purification device 100 through an outlet 513 (FIG. 14) of the primary filtration assembly 500 when increased output from the fluid purification device 100 is desired.

Although the manifold valve assembly 219 illustrated in FIG. 4 has three outputs, in some embodiments, the manifold valve assembly 219 may have any number of outputs as desired to supply fluid to various subassemblies or sensors.

Referring now to FIG. 5, shown is a cross section of the top assembly 200 of FIG. 4 along line 5-5 according to some embodiments of the present disclosure. As shown in FIG. 5, the bypass valve 218 connects the second output 223 of the manifold valve assembly 219 to the bypass hose 224 (the operation of the bypass valve 218 is discussed herein with respect to the nanofiltration assembly 300) and an outlet 227 is connected to the third output 225 of the manifold valve assembly 219. In some embodiments, the outlet 227 is a check valve to prevent back flow of fluid through the top assembly 200. Further, the flow path of the top assembly 200 from the fluid inlet 201 through the prefilter assembly 205 and out the manifold valve assembly 219 is shown.

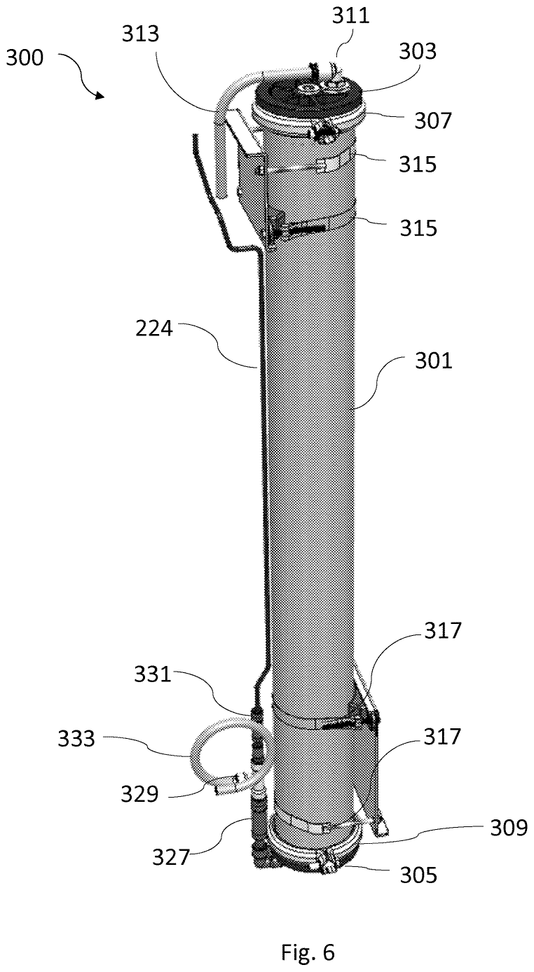

Referring now to FIG. 6, shown is a perspective view of the nanofiltration assembly 300 according to some embodiments of the present disclosure. The nanofiltration assembly 300 includes a body 301, a top cap 303, and a bottom cap 305. The top cap 303 and the bottom cap 305 are releasably secured to the respective top and bottom of the body 301 by a respective clamp 307, 309. The top cap 303 includes an inlet 311 with an inlet hose 313 connecting outlet 227 of the top assembly 200 to the inlet 311 of the nanofiltration assembly 300.

The nanofiltration assembly 300 also includes two first brackets 315 to secure the top assembly 200 to the nanofiltration assembly 300. The nanofiltration assembly 300 also includes two second brackets 317 to secure the bottom assembly 400 to the nanofiltration assembly 300. Although a two first brackets 315 and two second brackets 317 are shown to secure the nanofiltration assembly 300 to the respective top assembly 200 and bottom assembly 400, any number of brackets or other fasteners may be used to achieve a desired coupling. In some embodiments, the body 301 of the nanofiltration assembly 300 is sufficiently rigid to act as a structural post between the top assembly 200 and the bottom assembly 400 such that the nanofiltration assembly 300 may be configured as a central body for the fluid purification device 100. The nanofiltration assembly 300 is configured to support the top assembly 200 and the bottom assembly 400. Specifically, as best shown in FIGS. 1 and 2, the top assembly 200 and the bottom assembly 400 are secured to and supported by the nanofiltration assembly 300.

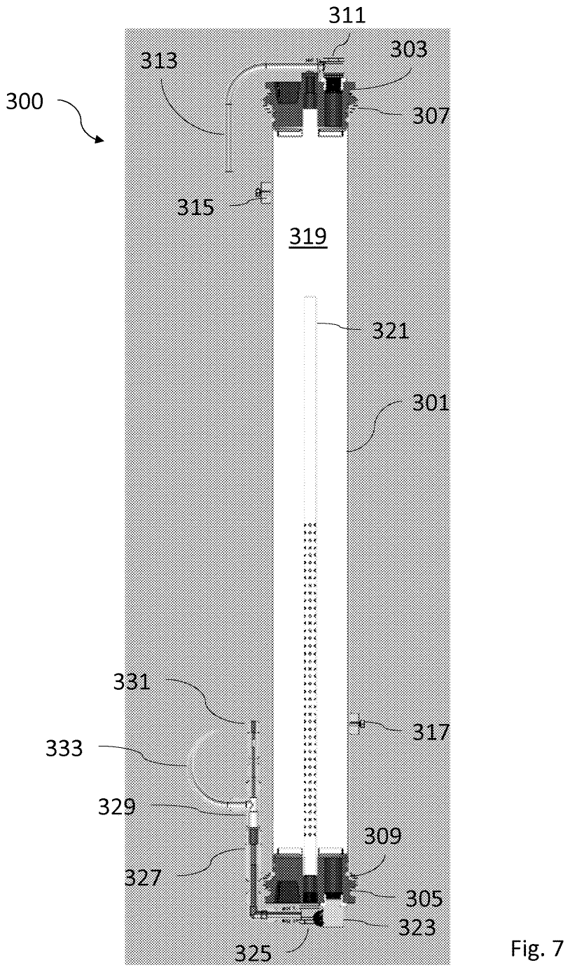

Referring now to FIG. 7, shown is a cross section view of the nanofiltration assembly 300 according to some embodiments of the present disclosure. As seen in FIG. 7, the inlet 311 on the top cap 303 provided fluid access to the interior of the body 301 housing a nanofilter 319. In some embodiments, the nanofilter 319 may be a nanofilter made of a spiral wound plastic membrane having pores to allow fluid to pass through while catching particulates therein. In some embodiments, the size of the pores in the nanofilter 319 will vary depending on desired flow rate and fluid conditioning. For example, smaller sized pores will capture more particulates, but by being more restrictive, the flow rate and pressure of the fluid will decrease. In some embodiments, the nanofilter 319 is a mechanical filter that relies on physical properties of the filter, e.g., the size of the pores or material, to condition the fluid as opposed to chemicals or reagents which are depleted during the use cycle.

As fluid is supplied to the nanofilter 319 via the inlet 311 the pressure from the inflow and gravity will force the fluid through the nanofilter 319 into the core 321. The fluid that passes through the nanofilter 319 into the core 321 is a nanofiltered fluid output by the nanofiltration assembly 300. In some embodiments, the fluid that flows through the core 321 will have no TDS or low TDS. The nanofiltered fluid is supplied to the interior outlet 325 while excess waste fluid or high TDS fluid flows to the exterior outlet 323 out of the fluid purification device 100. In some embodiments, the exterior outlet 323 is actuatable between a run position providing back pressure to prevent fluid from being discharged and a flush position to rinse, clean, or prepare the nanofiltration assembly 300 for storage.

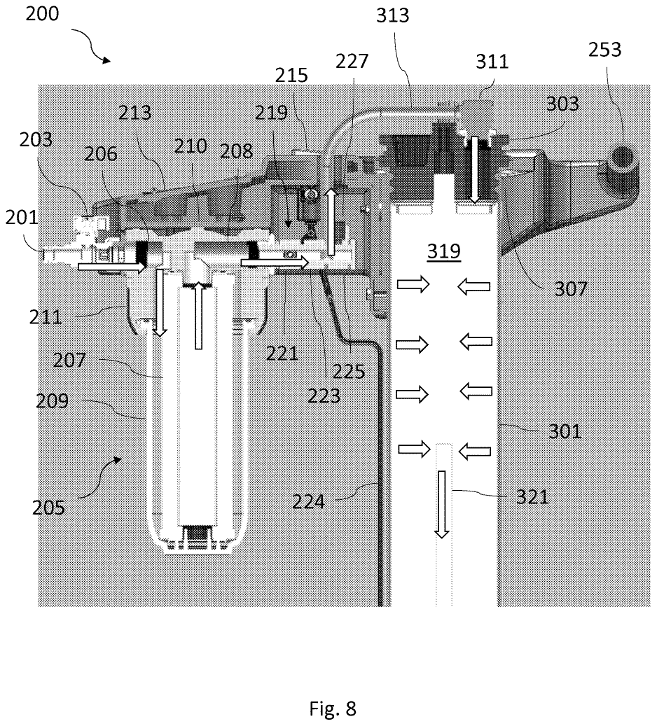

The interior outlet 325 is connected to a fluid blender 329 via a check valve 327. The fluid blender 329 is also connected to the bypass hose 224 via a separate check valve 331 (shown in FIG. 8). The check valves 327, 331 prevent fluid back flow to the nanofiltration assembly 300 and the top assembly 200, respectively. The fluid blender 329 is configured to mix the nanofiltered fluid from the nanofiltration assembly 300 and prefiltered fluid from the top assembly 200 provided to the fluid blender 329 via the bypass hose 224 to provide a blended fluid to an output hose 333. The blended fluid may comprise varying amounts of the nanofiltered fluid and the prefiltered fluid based on the flow of the prefiltered fluid from the top assembly 200 via the bypass hose 224. As shown in FIGS. 6 and 7, the fluid blender 329 comprises a T-junction fitting.

The fluid flow rate through the output hose 333 can be increased based on an increased flow of prefiltered fluid from the top assembly 200 to the fluid blender 329 caused by the rotation of the control knob 215 in the first direction. The increased flow of prefiltered fluid from the top assembly 200 to the fluid blender 329 increases a volume of blended fluid that flows into the output hose 333. As the bypass valve 218 is actuated to increase the flow of prefiltered fluid to the fluid blender 329 through the bypass hose 224, the blended fluid will have a higher level of TDS. The higher level of TDS is caused by the prefiltered fluid provided by though bypass hose 224 since the prefiltered fluid bypasses the nanofiltration assembly 300 and a portion of the TDS within the prefiltered fluid cannot be removed using the nanofiltration assembly 300. When greater magnitudes of prefiltered fluid are provided to the fluid blender 329, the level of TDS within the blended fluid also increases since greater amounts of prefiltered fluid are mixed into the blended fluid. Additionally, when greater magnitudes of prefiltered fluid are provided to the fluid blender 329, the flow rate of output from the fluid purification device 100 is also increased. For example, the output from the fluid purification device 100 may be output through an outlet 513 (FIG. 14) of the primary filtration assembly 500. The flow rate and TDS of the fluid are balanced depending on the desired application. For example, some cleaning applications, such as cleaning solar panels, can tolerate a higher level of TDS, so an increased flow rate may be desired.

As discussed herein, in some embodiments, the top assembly 200 and the nanofiltration assembly 300 can go through a flush operation. In the flush operation the prefilter 207 may be removed and the exterior outlet 323 is placed in a flush position. Fluid then flows through the top assembly 200 and into the nanofiltration assembly 300. Since the exterior outlet 323 is in the flush position, the fluid flows through the path of least resistance around the nanofilter 319 and out the exterior outlet 323, i.e., not through the nanofilter 319 into the core 321 and out the interior outlet 325. In this way any sediment, particulates, or stagnant fluid is flushed through the system. In some embodiments, an antifreeze or other preserving fluid may be flushed through the system. Such preserving fluids are typically ethanol based. The top assembly 200 and/or the nanofiltration assembly 300 may be stored with the antifreeze or preserving fluid. For example, it may be desirable to flush and store the fluid purification device 100 during the winter months or other periods of non-use as residual fluid may freeze damaging the system or the nanofilter 319 may become brittle after long periods of exposer.

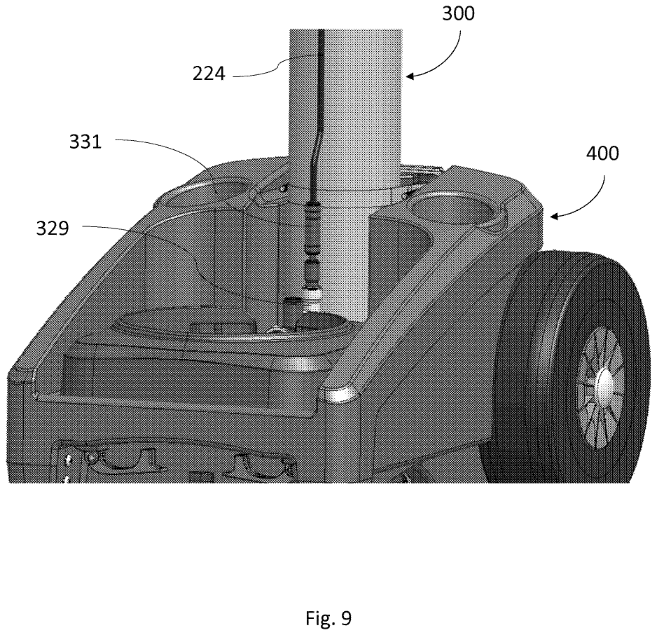

Referring now to FIG. 9, shown is a truncated cross sectional view of the top assembly 200 and the nanofiltration assembly 300 according to some embodiments of the present disclosure. In some embodiments, the inlet 311 is on top of the top cap 303 and the inlet hose 313 is connected to a side of the inlet 311 adjacent to the top cap 303. In this way, the top cap 303 can be removed without having to disconnect the inlet hose 313. In some embodiments, the inlet hose 313 acts as pseudo hinge when the top cap 303 is removed. This configuration may be desirable to facilitate removal of the top cap 303, for example, if the nanofilter 319 needs to be replaced. Further, the flow path through the top assembly 200 and the nanofiltration assembly 300 is shown.

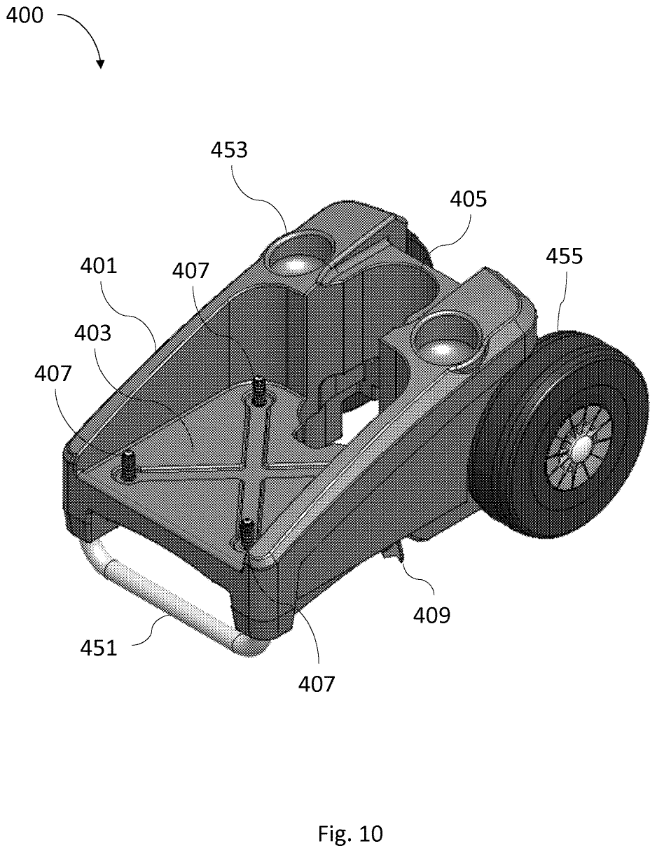

Referring now to FIG. 10, shown is a perspective view of the bottom assembly 400 according to some embodiments of the present disclosure. The bottom assembly 400 may include a chassis 401 with a platform 403 for receiving and supporting the primary filtration assembly 500 and an opening 405 for receiving the nanofiltration assembly 300. The bottom assembly 400 may also include a series of rubber grommets 407 mounted on a peg attached to a respective cam lever 409. The grommets 407 may be inserted into the primary filtration assembly 500 whereby the cam lever 409 is actuated to depress and expand the grommets 407 to lock the primary filtration assembly 500 in place. In some embodiments, an attachment screw or other fastener coupling the grommets 407 to the cam lever 409 may be tightened or loosened to adjust the compression of the grommets. In this way when the cam lever 409 is actuated, the grommets 407 with have increased or decreased grip strength when securing the primary filtration assembly 500. In some embodiments, the grommets 407 are adjustable to enable compatibility with non-standard/non-OEM parts or subsystems.

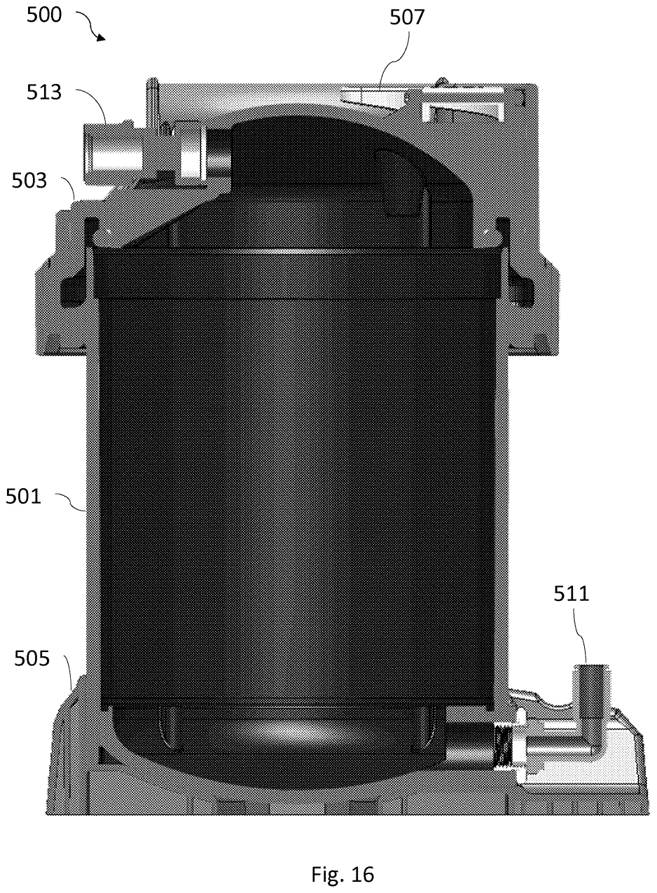

In some embodiments, the bottom assembly 400, similar to the top assembly 200, may include one or more convenience features. For example, a front leg 451, storage depression 453, and wheels 455. In some embodiments, the front leg 451 may serve as an additional handle to facilitate carrying or loading the fluid purification device 100 into a vehicle (shown in FIGS. 16A and 16B). In some embodiments, the front leg 451 may be replaced by additional wheels 455. In some embodiments, the storage depressions 453 are positioned under a respective draw latch 251 of the top assembly 200. In this way, cleaning tools can be slotted into the storage depressions 453 and secured against the top assembly 200 via the respective draw latch 251. This may be desirable when transporting cleaning tools with extended handles.

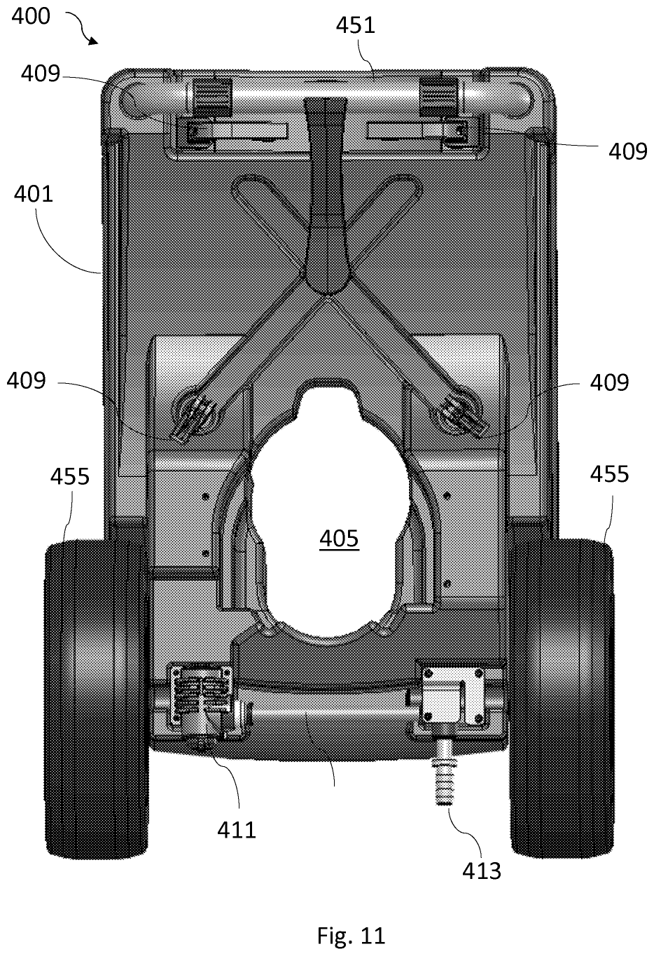

Referring now to FIG. 11, shown is a bottom view of the bottom assembly 400 according to some embodiments of the present disclosure. In some embodiments, the bottom assembly 400 includes a drain valve 411. The drain valve 411 is fluidly connected with a push connect fitting 413 by a fluid conduit 412. The drain valve 411 is connected in fluid communication with the exterior outlet 323 of the nanofiltration assembly 300 (shown in FIG. 11) to receive fluid from the exterior outlet 323. In some embodiments, the drain valve 411 is used to divert the fluid discharged through the exterior outlet 323 away from the fluid purification device 100 or into a drain.

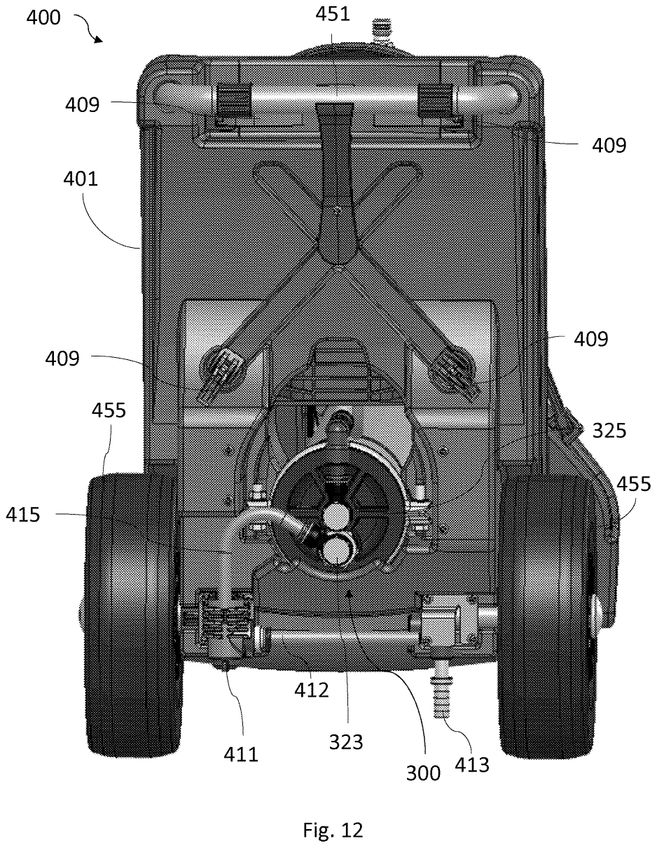

Referring now to FIG. 12, shown is a bottom view of the bottom assembly 400 with the nanofiltration assembly 300 installed according to some embodiments of the present disclosure. As shown, the exterior outlet 323 is connected to the drain valve 411 by a fluid conduit 415. In this way, when the fluid purification device 100 is fully assembled, the fluid is discharged through the exterior outlet 323 to the drain valve 411 using the fluid conduit 415 and fluid from the drain valve 411 is provided to the push connect fitting 413 to discharge fluid from the fluid purification device 100 near the edge of the bottom assembly 400. This configuration may be desirable since a hose can easily be attached and detached from the push connect fitting 413 to divert the fluid discharge away from the fluid purification device 100 or into a drain.

In some embodiments, the drain valve 411 is a flow metering device that is used to balance pressure in the nanofiltration assembly 300. For example, the drain valve 411 may be actuatable between a plurality of positions ranging from fully open to fully closed to adjust back pressure in the nanofiltration assembly 300. In this way, the flow rate through the nanofilter 319 and out the interior outlet 325 can be balanced in conjunction with the flow rate though the bypass hose 224 to achieve a desired flow rate and TDS of the fluid through the output hose 333 to the primary filtration assembly 500.

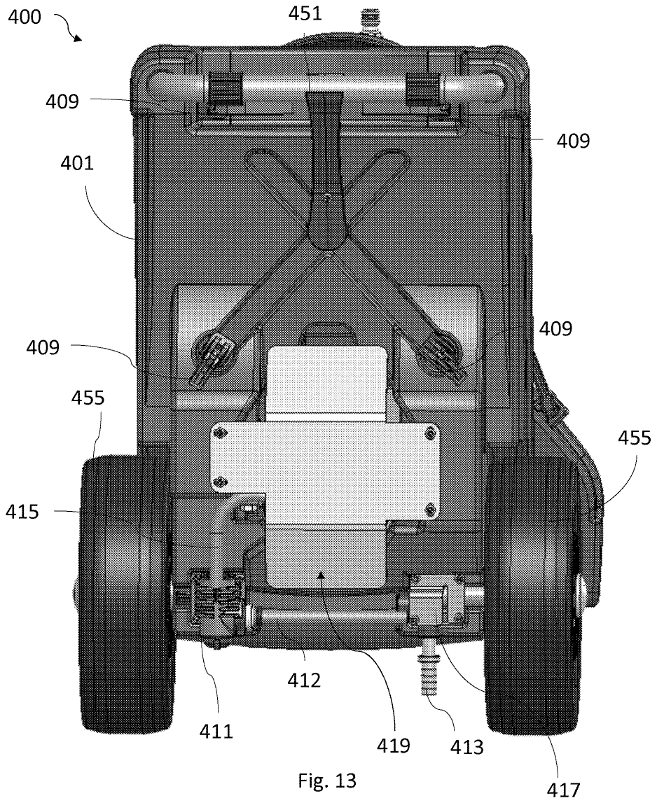

Referring now to FIG. 13, the bottom assembly 400 includes a fitting plate assembly 417. The fitting plate assembly 417 is configured to protect the push connect fitting 413 from external impacts, such as may occur during carrying or loading the fluid purification device 100 into a vehicle (shown in FIGS. 16A and 16B) or transport using wheels 455, that may cause damage to the push connect fitting 413. The fitting plate assembly 417 may be coupled to the bottom assembly 400 using one or more fasteners, for example screws. The fitting plate assembly 417 is disposed to at least partially surround the push connect fitting 413 while maintaining access for hose attachment to the push connect fitting 413.

The bottom assembly 400 includes a kickplate 419. The kickplate 419 is configured to provide a protective layer for a portion of the nanofiltration assembly 300 that extends through the bottom assembly 400. For example, the kickplate 419 may at least partially cover the exterior outlet 323, interior outlet 325, and/or the fluid connection between exterior outlet 323 and the fluid conduit 415. The kickplate 419 protects the exterior outlet 323, interior outlet 325, and/or the fluid connection between exterior outlet 323 and the fluid conduit 415 from external impacts, such as may occur during carrying or loading the fluid purification device 100 in to a vehicle (shown in FIGS. 16A and 16B) or transport using wheels 455, that may cause damage to such components. The kickplate 419 may be coupled to the bottom assembly 400 using one or more fasteners, for example screws. The kickplate 419 may comprise metallic material, such as stainless steel, aluminum, or coated steel sheet, to protect the exterior outlet 323, interior outlet 325, and/or the fluid connection between exterior outlet 323 and the fluid conduit 415.

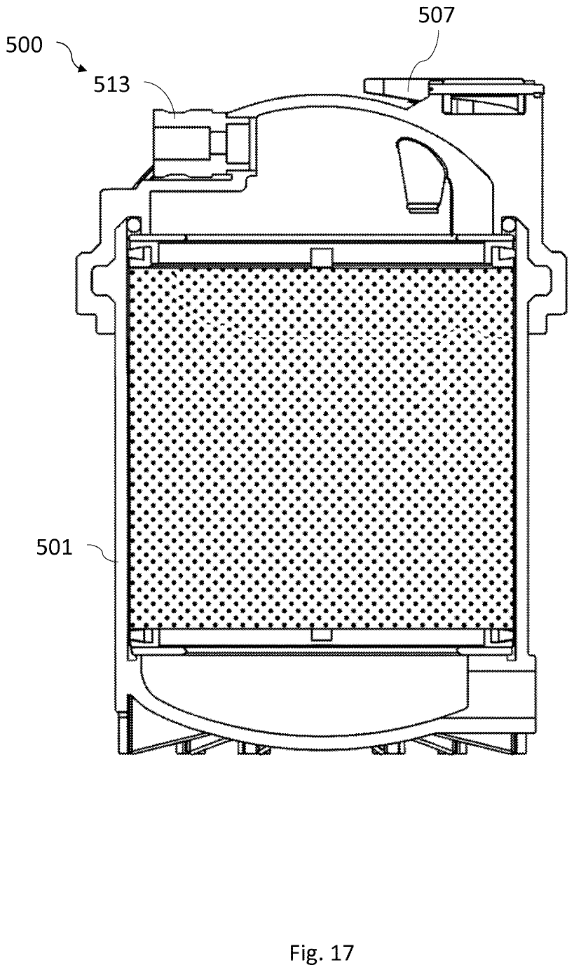

Referring now to FIG. 14, shown is a perspective view of the primary filtration assembly 500 according to some embodiments of the present disclosure. the primary filtration assembly 500 may include a tank 501 for housing a filtration medium (shown in FIG. 17) with a cover 503 and base 505. Fluid from the output hose 333 of the nanofiltration assembly 300 may enter the tank 501 via an inlet 511. As fluid is pumped into tank 501 and through the filtration medium, pressure in the tank 501 builds up and the fluid is forced through the filtration medium and out the outlet 513. In some embodiments, the cover 503 has a lever 507 to release the pressure in the tank 501 to facilitate removal of the cover 503. In some embodiments, the primary filtration assembly 500 may include a sensor 509 to measure the condition of the fluid therein, for example, the sensor 509 may be a TDS sensor.

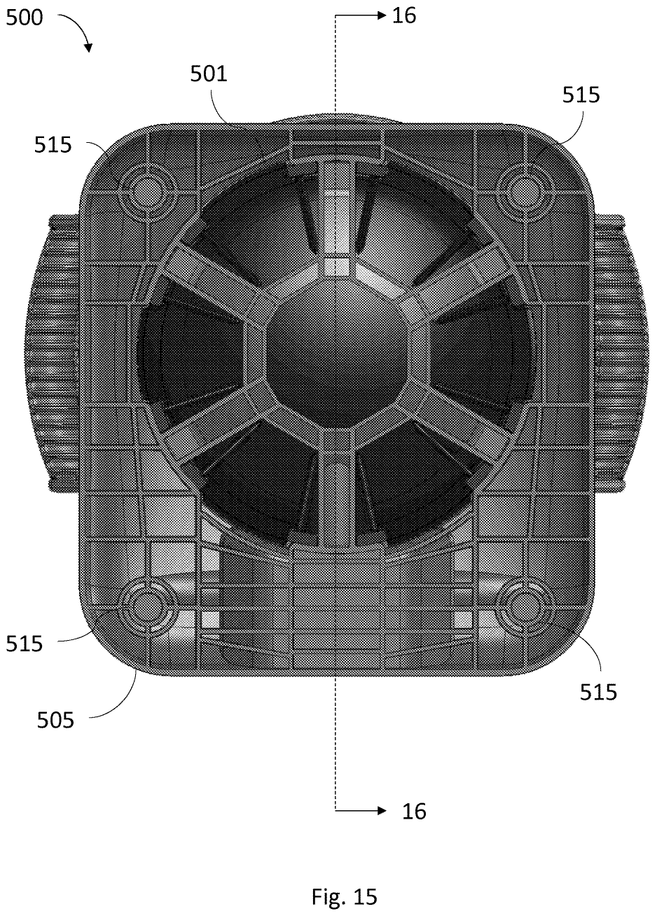

Referring now to FIG. 15, shown is a bottom perspective view of the primary filtration assembly 500 according to some embodiments of the present disclosure. In some embodiments, the tank 501 may be coupled to the base 505 via snap fit connection and the base 505 may have one or more holes 515 corresponding to the grommets 407 of the bottom assembly 400. In this way, the base 505 is received on the platform 403 of the bottom assembly 400 such that the grommets 407 are received into a respective hole 515 in the base 505. When the cam levers 409 are actuated the grommets 407 are depressed and expand inside the hole 515 to secure the primary filtration assembly 500 to the bottom assembly 400.

Referring now to FIG. 16, shown in a cross sectional view of the primary filtration assembly 500 along line 16-16 according to some embodiments of the present disclosure. FIG. 16 shows the interior of the tank 501 with the filtration medium removed. In some embodiments, the inlet 511 is a check valve to prevent the back flow of fluid to the output hose 333.

Referring now to FIG. 17, shown is a cross sectional view of the primary filtration assembly 500 according to some embodiments of the present disclosure. In some embodiments, the primary filtration assembly 500 may be the same as or similar to the filtration device described in U.S. Pat. No. 11,911,720 and US Patent Publication No. 2020/0010338, the contents of which are incorporated by reference herein. In some embodiments, the primary filtration assembly 500 may be detachably coupled to the fluid purification device 100 and the bottom assembly 400 to allow the primary filtration assembly 500 to be used independently therefrom. In some embodiments, the primary filtration assembly 500 is mounted on the bottom assembly 400 to prevent tipping as the primary filtration assembly 500 may hold more fluid than the top assembly 200 and the nanofiltration assembly 300.

In some embodiments, the primary filtration assembly 500 utilizes a chemical, reagent, or resin filtration medium to output a pure fluid. Such filtration mediums deplete over time through use. As the filtration medium is depleted the TDS in the output fluid increases. By filtering the fluid, for example with the prefilter assembly 205 and/or the nanofiltration assembly 300, the lifespan of the filtration medium is extended since the filtration medium in the primary filtration assembly 500 is removing less TDS from the fluid.

A flow rate of the pure fluid output by the primary filtration assembly 500 is based on a volume of fluid that flows into the primary filtration assembly 500 from the output hose 333. For example, when the fluid comprises the blended fluid, the flow rate of the pure fluid output may be a greater magnitude than a flow rate when only nanofiltered fluid is being provided to the output hose. Accordingly, when greater amounts of prefiltered fluid are provided to the fluid blender 329 and the blended fluid comprises greater amounts of the prefiltered fluid, the flow rate of the pure fluid from the primary filtration assembly 500 is also increased. As described above, the amount of prefiltered fluid being provided to the fluid blender 329 may be variably controlled by the control knob 215. As a result, the flow rate of the pure fluid from the primary filtration assembly 500 is also variably controlled by the control knob 215.

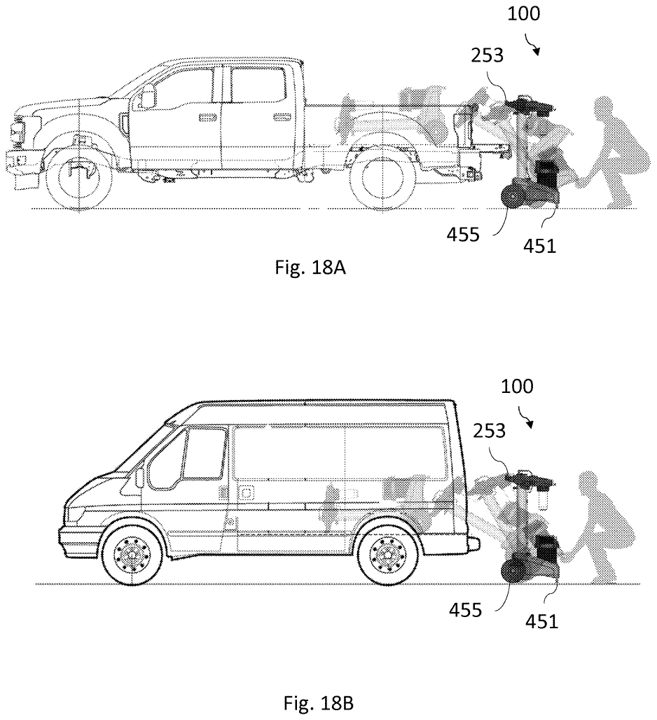

Referring now to FIGS. 18A and 18B, shown is a side view of the fluid purification device 100 being loaded/unloaded into a vehicle according to some embodiments of the present disclosure. In some embodiments, the leg 451 is used as a handle to carry or load the fluid purification device 100 into a vehicle. The fluid purification device 100 is tilted as the leg 451 is lifted, pivoting about the wheels 455. In this way, the entire fluid purification device 100 is laid on its back with the handle 253 acting as an interim leg. This arrangement may be desirable for transport or storage as the fluid purification device 100 is less likely to tip or rollover.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A fluid purification device comprising:
a first filter comprising a prefilter in fluid communication with a fluid inlet for the fluid purification device, the first filter configured to receive fluid from the fluid inlet and output prefiltered fluid;
a second filter comprising a nanofilter in fluid communication with the first filter, the second filter configured to receive the prefiltered fluid and output nanofiltered fluid;
a bypass valve in fluid communication between the first filter and the second filter, the bypass valve configured to variably control flow of the prefiltered fluid therethrough;
a fluid blender in fluid communication with the bypass valve and the second filter, the fluid blender configured to receive the prefiltered fluid from the first filter via the bypass valve and the nanofiltered fluid from the second filter and output a blended fluid; and
a third filter comprising a filtration medium in fluid communication with the fluid blender, the third filter configured to receive the blended fluid and output pure fluid.

2. The fluid purification device of claim 1, further comprising a manifold valve assembly in fluid communication with the prefilter, the manifold valve assembly configured to direct the prefiltered fluid between one or more outputs of the manifold valve assembly.

3. The fluid purification device of claim 2, wherein the one or more outputs of the manifold valve assembly comprises a first output in fluid communication with the bypass valve to direct the prefiltered fluid into the bypass valve.

4. The fluid purification device of claim 3, wherein the one or more outputs of the manifold valve assembly further comprise a second output in fluid communication with the third filter to direct the prefiltered fluid into the third filter.

5. The fluid purification device of claim 4, further comprising a bypass hose extending between the bypass valve and the fluid blender, the bypass hose configured to transport the prefiltered fluid from the manifold valve assembly to the fluid blender.

6. The fluid purification device of claim 1, further comprising a top assembly comprising the fluid inlet, wherein the first filter is coupled to the top assembly to produce the prefiltered fluid from the fluid from the inlet.

7. The fluid purification device of claim 6, wherein the top assembly comprises a control knob configured to actuate the bypass valve to regulate a flow of the prefiltered fluid from the first filter to the fluid blender.

8. The fluid purification device of claim 7, wherein the control knob is rotatable between a plurality of discrete positions to actuate the bypass valve variably adjust the flow of the prefiltered fluid from the first filter to the fluid blender.

9. The fluid purification device of claim 8, wherein the blended fluid comprises a greater volume of prefiltered fluid when the flow of the prefiltered fluid to the fluid blender is increased.

10. The fluid purification device of claim 8, wherein a flow rate of the pure fluid changes in response to an adjustment of the flow of the prefiltered fluid from the first filter to the fluid blender.

11. The fluid purification device of claim 8, wherein the top assembly comprises a plurality of flow indicators, each flow indicator corresponding to one of the plurality of discrete positions of the control knob.

12. The fluid purification device of claim 6, further comprising a nanofiltration assembly comprising the second filter, wherein the top assembly is secured to the nanofiltration assembly.

13. The fluid purification device of claim 12, further comprising a primary filtration assembly comprising the third filter, wherein the primary filtration assembly is detachably coupled to a bottom assembly.

14. The fluid purification device of claim 13, wherein the bottom assembly is secured to the nanofiltration assembly.

15. The fluid purification device of claim 1, wherein the fluid blender comprises a T-junction fitting.

16. A fluid purification device comprising:
a top assembly comprising a prefilter in fluid communication with a fluid inlet for the fluid purification device, the prefilter configured to receive fluid from the fluid inlet and output prefiltered fluid;
a nanofiltration assembly comprising a nanofilter in fluid communication with the prefilter, the nanofilter configured to receive the prefiltered fluid and output nanofiltered fluid;
a primary filtration assembly comprising a filtration medium in fluid communication with the nanofilter, the primary filtration assembly configured to receive the nanofiltered fluid and output pure fluid;
a fluid blender in fluid communication with the top assembly, the nanofiltration assembly, and the primary filtration assembly, the fluid blender configured to receive at least one of the prefiltered fluid and the nanofiltered fluid and output a blended fluid to the primary filtration assembly; and
a bottom assembly supporting the primary filtration assembly,
wherein the bottom assembly and the top assembly are secured to and supported by the nanofiltration assembly.

17. The fluid purification device of claim 16, further comprising a bypass valve in fluid communication between the prefilter and the nanofilter, the bypass valve configured to variably control flow of the prefiltered fluid therethrough to the fluid blender.

18. The fluid purification device of claim 17, wherein the top assembly comprises a control knob configured to actuate the bypass valve to variably control flow of the prefiltered fluid from the top assembly to the fluid blender.

19. The fluid purification device of claim 18, wherein the control knob is rotatable between a plurality of discrete positions to actuate the bypass valve variably adjust the flow of the prefiltered fluid from the top assembly to the fluid blender.

20. The fluid purification device of claim 19, wherein the blended fluid comprises a greater volume of prefiltered fluid when the flow of the prefiltered fluid to the fluid blender is increased.
